(19) United States
(12) Patent Application Publication
(10) Pub. No.: US 2025/0064655 A1
(43) Pub. Date: Feb. 27, 2025

(54) INCLINABLE LEG REST DEVICE FOR A WHEELCHAIR

(71) Applicant: NEW LIVE INGENIERE, Betschdorf (FR)

(72) Inventor: Michel OHRUH, Betschdorf (FR)

(21) Appl. No.: 18/723,983

(22) PCT Filed: Oct. 27, 2022
(86) PCT No.: PCT/EP22/80034

§ 371 Date: Jun. 25, 2024

(30) Foreign Application Priority Data
Dec. 29, 2021 (FR) 2114639
Dec. 29, 2021 (FR) 2114642

(51) Int. Cl. A61G 5/12; A47C 7/50

(52) U.S. Cl. CPC A61G 5/127; A47C 7/5068

(57) ABSTRACT

The inclinable leg rest device for a wheelchair having a wheeled frame to which a seat is attached includes a structure mounted pivotably on the frame in order for the user to be able to assume a position between two extreme positions of the legs being bent and the legs being straightened. The leg rest device also includes a board provided with pads for calf placement and slidably mounted on the pivoting structure so as to enable a lengthwise adjustment and an adaptation of the positioning of the pads. The board is slidably mounted on the pivoting structure through a curved guide path which is convex on the side that supports the legs.

### CROSS-REFERENCE TO RELATED APPLICATIONS

See Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

### 1. Field of the Invention

The present invention relates to the field of wheelchairs, and more particularly to an inclinable leg rest device.

### 2. Description of Related Art Including Information Disclosed Under 37 CFR 1.97 and 37 CFR 1.98

A wheelchair mainly comprises a wheeled frame to which a seat is attached, which seat further comprises, in addition to a seat portion, a backrest and armrests, a leg rest consisting of a board provided with pads for resting the calves and the angle of which is adjustable by being pivotably mounted on the frame, so that the user can find the most comfortable position possible between the two extreme positions, with the legs bent and with the legs straightened.

Furthermore, the leg rest typically has a footrest at its free end, in the form of a platform or plate with an adjustable angle.

Finally, the pads and footrest preferentially comprise adjustment means, enabling the user to find the most comfortable position.

However, the possibility of varying the angle of the leg rest in relation to the wheelchair poses a problem, namely that the pivot axis of the leg rest and that of the user's knee joint are not coaxial, but very eccentric, the pivot axis of the leg rest being located below and behind that of the knee joint.

Thus, when moving from the bent-leg position to the straightened-leg position, for example, the distance between the footrest and the axis of the knee joint decreases, leaving less room for the legs, and vice versa during folding.

To overcome this disadvantage, the leg rest device comprises a structure pivotably mounted on the wheelchair frame, whereupon the padded board can slide longitudinally, perpendicular to the pivot axis, so as to allow the distance between the footrest and the knee axis to be adapted and adjusted.

However, there is another problem: when moving from the bent-leg position to the straightened-leg position, the feet are supported on the footrest, but the pivot axis of the structure supporting the leg rest is positioned below the knee axis, so that the user's calves no longer touch the pads, which causes discomfort for the user, since the legs are hyperextended.

Of course, in the reverse movement from the straight-leg position to the bent-leg position, the symmetrical problem arises, namely that if the calves are resting on the pads, the feet are no longer attached to the footrest.

To overcome this disadvantage, various devices have been proposed to vary the height of the pads, often manually, sometimes automatically, using a set of connecting rods for example. However, these devices have disadvantages, particularly in that, to achieve the objectives of adjusting the height of the pads, the initial position, which is the most comfortable for the user, is modified.

### BRIEF SUMMARY OF THE INVENTION

The aim of the present invention is to remedy the various above-mentioned disadvantages by offering a leg rest device of simple design, which enables the user to switch from a bent-leg position to a straightened-leg position and vice versa, without modifying the initial position which is chosen to be the most comfortable for the user.

The inclinable leg rest device for a wheelchair according to the invention, wherein said wheelchair comprises a wheeled frame to which a seat is attached, which seat further comprises a seat portion, a backrest and armrests, said leg rest comprising a structure mounted pivotably on said frame in order for the user to be able to assume a position between two extreme positions of the legs being bent and the legs being straightened, said leg rest additionally comprising a board or the like provided with pads for calf placement, which board is slidably mounted on said pivoting structure so as to enable a lengthwise adjustment and an adaptation of the positioning of said pads, and is characterized in that said board is slidably mounted on said pivoting structure through a curved guide path, which is convex on the side that supports the legs.

Thus, the curvature of the path traveled by the board during translation generates an elevation of the board relative to the general plane of the pivoting structure, which is sufficient to compensate for the offset caused by the pivoting.

According to an additional feature of the inclinable leg rest device according to the invention, the pivoting structure is moved by an electric actuator, secured to said pivoting structure, and whose rod is secured to the frame, through a pivot with an axis eccentric with respect to the pivot axis of said pivoting structure.

According to another additional feature of the inclinable leg rest device according to the invention, the movable board is connected to the frame by means of a strap or the like, which passes over return pulleys, one of which is movable under the effect of the pivoting, so as to generate a modification of the path of said strap or the like during the folding operation, and vice versa, and thus the displacement of said movable board.

According to another additional feature of the inclinable leg rest device according to the invention, the pivoting structure comprises a first return pulley proximate to the pivot axis of said pivoting structure, while a connecting rod pivotably mounted by one end on the frame and extending under said pivoting structure comprises, at its other end, a return pulley capable of moving away from said first return pulley during the folding operation, and vice versa.

### BRIEF DESCRIPTION OF THE SEVERAL VIEWS OF THE DRAWINGS

The advantages and features of the inclinable leg rest device according to the invention will emerge more clearly from the description which follows and which relates to the appended drawing, which shows one non-limiting embodiment thereof.

FIG. 1 shows a schematic profile elevation view of a leg rest device according to the invention in the folded position.

FIG. 2 shows a schematic profile elevation view of the same leg rest device in an intermediate deployed position.

FIG. 3 shows a schematic profile elevation view of the same leg rest device in the deployed position.

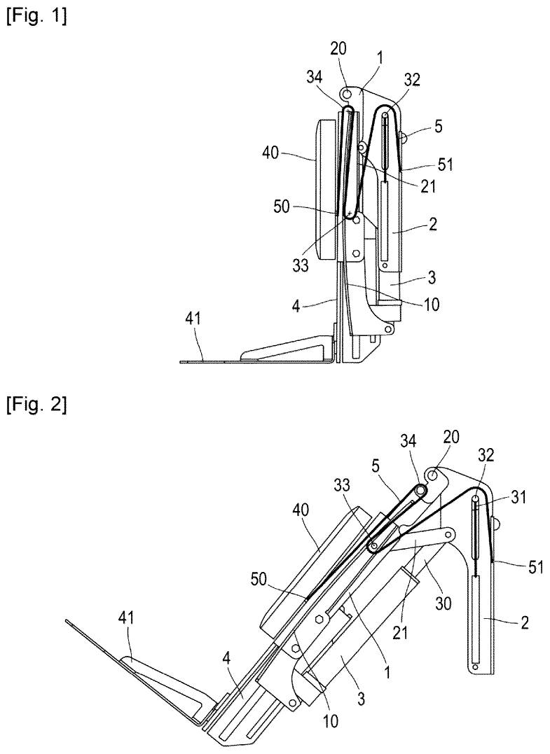

### DETAILED DESCRIPTION OF THE INVENTION

These figures show a leg rest device according to the invention, which comprises a structure 1 pivotably mounted on a part 2 of a wheelchair frame (not shown), around a pivot 20 and under the action of an actuator 3, while a board 4 is slidably mounted on the structure 1. This board 4 is equipped with pads 40, only one of which is visible, designed to support the user's calves, and has a footrest plate 41 at its free end.

The structure 1 is pivoted by the actuator 3, which is preferably electric and pivotably secured to the structure 2, with its rod 30 secured to part 2 of the frame.

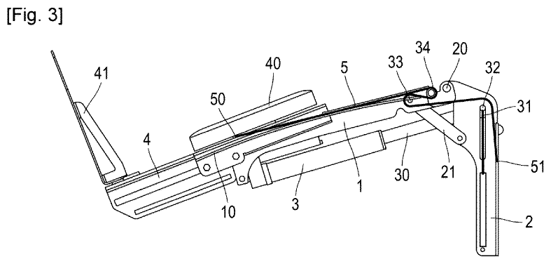

The end of the rod 30 carries a pulley 31 via a pivot 32 secured to the part 2 of the frame, with its axis parallel to that of the pivot 20, and eccentric with respect to the latter. The extension stroke of the rod 30 causes the structure 1 to deploy, as shown in FIGS. 2 and 3.

As already explained, it is necessary to lengthen the leg rest part during deployment, as the distance between the leg rest and the axis of the knee joint decreases, which is achieved by sliding the board 4 over the pivoting structure 1. However, this translation movement must be motorized.

Sliding in one direction or the other is achieved by modifying the path traveled by a strap 5 or the like, shown transparently in these figures, by lengthening or shortening the distance separating its two ends, one of which 50 is attached to the movable board 4, while the other 51 is attached to the part 2 of the frame.

It should be noted that, by no means restrictively, a strap is preferentially used.

This shortening or lengthening is obtained by pivoting the structure 1, under the action of the jack 3, through the displacement of a return pulley 33, which is mounted at the free end of a connecting rod 21, articulated on the part 2 of the frame, and which extends under the structure 1. Furthermore, the structure 1 comprises a return pulley 34 proximate to the pivot 20.

Thus, the strap 5 passes successively, from the attachment of its end 50 to the movable board 4, over the return pulley 34, over the return pulley 33 passing under the pivoting structure 1, then over the pulley 31 before being attached to the part 2 of the frame by its end 51.

When the structure 1 is pivoted to fold, the connecting rod 21 is forced to fold and its return pulley 33 moves away from the return pulley 34, which lengthens the path of the strap 5 and thus causes the board 4 to slide toward the pivot 20. Conversely, when the structure 3 is deployed, the return pulley 33 moves closer to the return pulley 34, which shortens the path of the strap 5 and allows the board 4 to move away from the pivot 20.

This configuration allows the board 4 to move as the structure 1 pivots under the action of the jack 3.

While this architecture enables the automatic translational movement of the board 4 when folding or unfolding, it does not compensate for the variation in height of the legs in relation to the pads 40.

However, according to the invention, the board 4 slides on the structure 1 through a curved guideway 10, which is upwardly convex, that is, convex in the direction of the board 4.

Thus, when the leg rest device is raised, that is, when the structure 1 is raised as shown in FIGS. 2 and 3, in addition to lengthening the leg rest, without changing the adjustment between the footrest 41 and the pads 40, the latter, following the curvature of the guideway 10, move away from the general plane of the structure 1 and vice versa when folded.

According to the invention, the height of the pads 40 is automatically adjusted during pivoting.

I claim:

1. An inclinable leg rest device for a wheelchair, wherein said wheelchair comprises a wheeled frame (2) to which a seat is attached, which seat further comprises a seat portion, a backrest and armrests, said leg rest comprising a structure (1) mounted pivotably on said frame (2) in order for the user to be able to assume a position between two extreme positions of the legs being bent and the legs being straightened, said leg rest additionally comprising a board (4) or the like provided with pads (41) for calf placement, which board is slidably mounted on said pivoting structure (1) so as to enable a lengthwise adjustment and an adaptation of the positioning of said pads (41), characterized in that said board (4) is slidably mounted on said pivoting structure (1) through a curved guide path (10), which is convex on the side that supports the legs.

2. The inclinable leg rest device according to claim 1, characterized in that the pivoting structure (1) is moved by an electric jack (3), secured to said pivoting structure (1), and whose rod (30) is secured to the frame (2), through a pivot with an axis eccentric with respect to the pivot axis (20) of said pivoting structure (2).

3. The inclinable leg rest device according to claim 1 or claim 2, characterized in that the movable board (4) is connected to the frame (2) by means of a strap (5) or the like, which passes over return pulleys (31, 33, 34), one of which (33) is movable under the effect of the pivoting, so as to generate a lengthening of the path of said strap (5) or the like during the folding operation, and vice versa, and thus the displacement of said movable board (4).

4. The inclinable leg rest device according to claim 3, characterized in that the pivoting structure (1) comprises a first return pulley (34) proximate to the pivot axis (20) of said pivoting structure (2), while a connecting rod (21) pivotably mounted by one end on the frame (2) and extending under said pivoting structure (1) comprises, at its other end, a return pulley (33) capable of moving away from said first return pulley (34) during the folding operation, and vice versa.
